(19) United States
(12) Patent Application Publication
(10) Pub. No.: US 2010/0176929 A1
(43) Pub. Date: Jul. 15, 2010

(54) Efficient Protocol for Reverse Direction Data Transmission

(76) Inventors: Mustafa Ozdemir, Arlington, MA (US); Daqing Gu, Burlington, MA (US); Jinyun Zhang, Cambridge, MA (US)

Correspondence Address: MITSUBISHI ELECTRIC RESEARCH LABORATORIES, INC., 201 BROADWAY, 8TH FLOOR, CAMBRIDGE, MA, 02139, US

(21) Appl. No.: 11/993,054

(22) PCT Filed: Jun. 20, 2005
(86) PCT No.: PCT/US05/21670

§ 371 Date: Mar. 30, 2010

(51) Int. Cl. H04Q 5/22

(52) U.S. Cl. 340/10.4

(57) ABSTRACT

A method, system, and computer program product for wireless communication between an initiator station and a responder station. The method includes assigning a transmit window having a predefined window duration to the initiator; sending a request-to send signal (S41) from the initiator to the responder; sending a clear-to-send (S42) signal and a request for reverse transmission from the responder to the initiator; sending forward data and a reverse transmission permission indicator from the initiator to the responder, and sending reverse data from the responder to the initiator within the transmit window assigned to the initiator.

### BACKGROUND OF THE INVENTION

1. Field of the Invention

A method, apparatus, system and computer program product implementing a reverse direction protocol arranged to transfer data in reverse direction without initiating a new medium access contention procedure by a responder.

2. Discussion of the Background

Presently, 802.11a/b/g Wireless Local Area Networks (WLANs) provide adequate performance for today's wireless networking applications. However, as wireless multimedia and other new applications emerge, higher WLAN data throughput will be required. Key considerations in architecting the next generation of WLAN are costs and robust performance. In addition to new Physical (PHY) technologies, new Medium Access Control (MAC) features maximizing throughput will be required to reliably meet the higher throughput requirements.

The Upcoming IEEE standard 802.11e defines a channel access mechanism called Hybrid Coordination Function (HCF). The latest draft of the standard is IEEE 802.11e draft/D13.0, Part 11: Wireless Medium Access Control (MAC) and physical layer (PHY) specifications: Medium Access Control (MAC) Quality of Service Enhancements, January 2005, the entire contents of which are incorporated herein by reference. The HCF uses both a contention-based channel access method, called the enhanced distributed channel access (EDCA) mechanism for contention based transfer and a controlled channel access, referred to as HCF Controlled Channel Access (HCCA) mechanism, for contention free transfer. Stations (STAs) may obtain transmission opportunities (TXOPs) using one or both of the channel access mechanisms. A STA defined in this invention can be a wireless communication terminal or an access point (AP) of the WLAN.

A STA that owns the TXOP may start an exchange of data frames. This STA is called the initiator. The STA, which receives the frames from and responds to an initiator in a frame exchange sequence, is called responder. In the legacy IEEE802.11 standards such as 802.11a/b/g/e, the data frames are transmitted one by one from initiator to responder in one direction in a given TXOP. There is no mechanism for responder to do reverse data transmission during the TXOP owned by initiator. However, there are so many applications that require real-time bidirectional communication such as VoIP. Furthermore, many transmission protocols including IEEE802.11, TCP etc require acknowledgements (Acks) continuously during the transmission. It is shown that the performance can get at least 10% better when the reverse direction protocol is incorporated.

To address these problems, an industrial alliance called TGnSync has been formed to develop a unified proposal for next-generation high throughput WLAN called IEEE802.11n. The TGnSync has proposed the protocol shown in FIGS. 1-2. The current version of TGnSync proposal is known as IEEE 802.11-04/0889r6, “TGn Sync Proposal Technical Specification”, May, 2005, the entire contents of which are incorporated herein by reference.

As shown in FIG. 1, in the conventional TGnSync Reverse Data Exchange, a STA that is an initiator may advertise readiness to provide reverse direction data flow by including Reverse Direction Limit (RDL) element in its Initiator Aggregation Control (IAC) frame. A responder STA may request a reverse direction allocation from the initiator using a Reverse Direction Request (RDR) element in its Responder Aggregation Control (RAC) frame. The RDR element contains the length of data the responder would like to send, plus a default Modulation and Coding Scheme (MCS). An MCS FeedBack (MFB) element may accompany the RDR, and the initiator may determine an updated MCS based on their contents.

The Initiator sets the granted Reverse Direction Grant (RDG) duration long enough to include the duration of reverse data plus any expected responses. The duration granted by the RDG for reverse data may be less than the requested duration, in which case the responder must reduce the amount of data it sends. The responder can also itself reduce the amount of reverse data it sends. Any response duration no longer than the RDG duration is valid. Thus, the reverse direction protocol shown in FIG. 1 uses a 3-way handshake.

FIG. 2 shows a flow chart for the conventional TGnSync Reverse Data Exchange corresponding to the timing chart of FIG. 1. The method begins with the initiator sending an IAC frame with readiness information to provide RD data flow (S21). The responder then sends its responses (S22). The initiator check to determine whether there is a reverse direction (RD) request in the responder's response (S23). If ‘no’, the initiator sends his data called forward (FWD) data (S27) followed by the responder sending its responses (S28). However, if the initiator determines that there is an RD request in the responder's response, the initiator sends an RD grant along with its data (S24). Afterwards, the responder sends its RD data and responses (S25). The process ends when the initiator sends its responses (S26).

A fundamental problem with TGnSync proposal is that it introduces two new control frames that are IAC and RAC respectively for reverse direction data transmission. Even though these new frames are used for multi-purposes, the cost they bring on is very high and not tolerable in terms of implementation practices due to their complexities. Moreover, these new control frames are longer than the legacy control frames so they cause more overhead in the transmission.

### SUMMARY OF THE INVENTION

The present invention is directed a reverse direction data exchange protocol that is simpler and more efficient than what has been proposed by the TGnSync alliance. This protocol does not require the two new control frames, IAC and RAC proposed by the TGnSync alliance. Instead, the legacy control frames, Request to Send (RTS) and Clear to Send (CTS), are used in a novel manner so as to provide a capability for reverse direction data transmission. The proposed scheme is much simpler compared to the TGnSync proposal. In addition, it does not put any burden on the upcoming IEEE 802.11n standard. Furthermore, the performance of the proposed protocol is the same as TGnSync's protocol, and even better in some scenarios.

### BRIEF DESCRIPTION OF THE DRAWINGS

FIG. 1 is a process chart corresponding to the conventional TGnSync proposal;

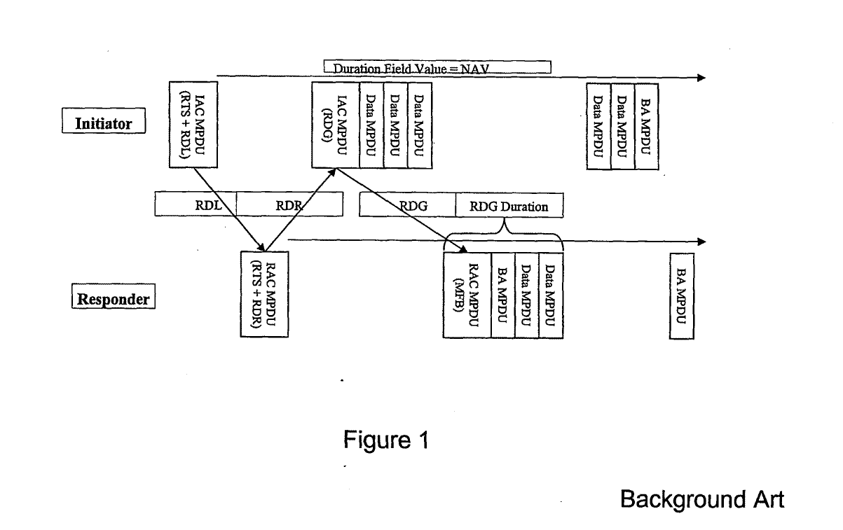

FIG. 2 is a flow chart corresponding to the conventional TGnSync proposal;

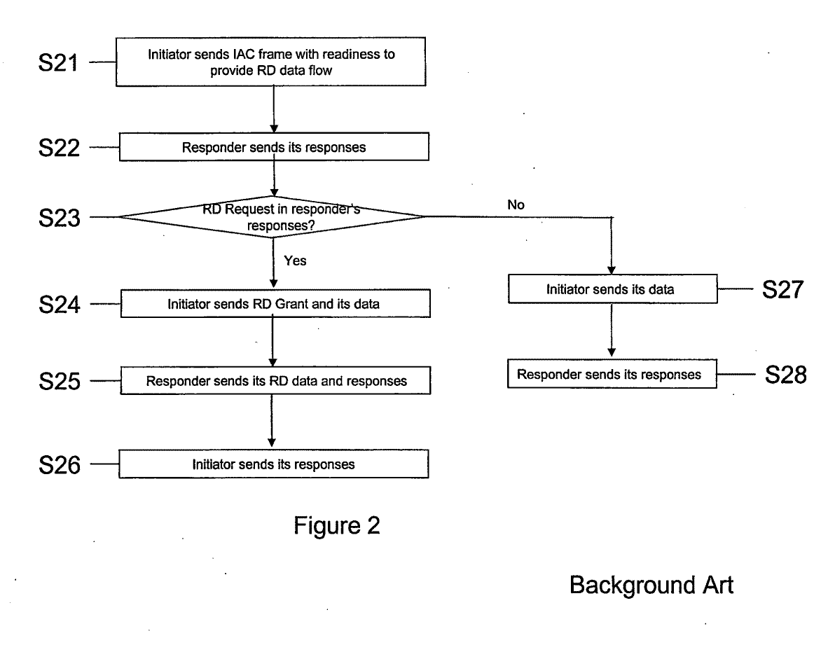

FIG. 3 is a timing chart according to one embodiment of the invention;

FIG. 4 is a flow chart corresponding to FIG. 3;

FIG. 5 is a timing chart according to one embodiment of the invention;

FIG. 6 is a flow chart corresponding to FIG. 5;

FIG. 7 is a timing chart according to one embodiment of the invention;

FIG. 8 is a flow chart corresponding to FIG. 7;

FIG. 9 is a timing chart according to one embodiment of the invention;

FIG. 10 is a flow chart corresponding to FIG. 9;

FIG. 11 is a network on which the present invention operates;

FIG. 12 is a diagram of a MAC layer associated with the present invention;

FIG. 13 is a diagram of a MAC header associated with the present invention;

FIG. 14 is a simplified block diagram of a WLAN card used with the present invention; and

FIG. 15 is a functional block diagram of a computing device used in association with the invention.

### DETAILED DESCRIPTION OF THE INVENTION

As noted previously, when a device is granted permission to transmit, the duration of this transmission period is called a transmit opportunity (TXOP). The present invention makes more efficient use of this TXOP by intelligently allocating the TXOP for both forward (FWD) and reverse path communications. That is, any remaining TXOP of an initiator is granted by the initiator to a corresponding responder upon the reception of responder's request to send if the requested duration of the responder's desired transmission is less than the remaining TXOP. Grant is given only when a BA (BlockAck) response is expected from the responder. Reverse direction data is either piggybacked with, or separated by a small interval from, the BA of the responder. The initiator grants its remaining TXOP when it has no more data to send. The responder only transmits reverse direction data with the same TID (Traffic ID) or AC (Access Category) so as not to violate the existing rules.

The responder can request a grant inside a Long Network Allocation Vector (LongNAV) duration. In other words, usage may be limited to LongNAV protection. Moreover, the initiator maintains channel ownership during the transmission. That is, the channel is never assigned/reassigned to the responder. This provides simplicity in implementation by not involving the responder with an external or internal time scheduler. Also, the TXOP of the initiator is protected by way of the exchange of RTS/CTS with the responder.

Also, the responder is preferably allowed to transmit only one data frame so that the return of TXOP to initiator is simplified. If the initiator fails to decode the signal field in the responder's transmission, the initiator then reverts to CCA (Clear Channel Assessment) mechanism. The initiator gets the channel back at the conclusion of a SIFS (Short Inter Frame Space) after the end of energy detection.

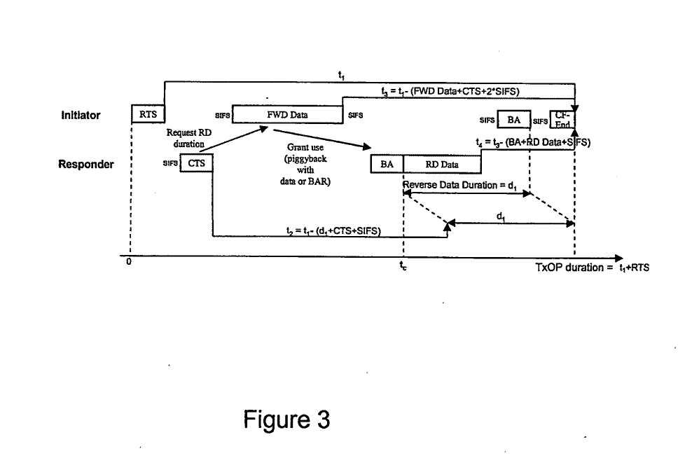

FIG. 3 shows a first embodiment of the present invention. Here, the initiator sends a RTS which includes a LongNAV duration of TXOP. Upon reception of RTS, the responder checks if it has any data that need to send. If the responder does need to send data in the reverse direction, the responder will determine the duration needed for the reverse direction data transmission. In the normal use of RTS/CTS, as defined in the legacy IEEE 802 standards, the value of duration field in CTS must be the duration in RTS minus the sum of CTS transmission time and SIFS (short interframe space). However, in the proposed reverse direction data transmission protocol, the responder subtracts the sum of reverse data duration and CTS and SIFS from the duration value in duration field of RTS (i.e., calculates t₂=t₁−(d₁+CTS+SIFS)) and sends CTS with this modified duration (t₂) in the duration field to initiator. The initiator checks the duration field in CTS sent by the responder to see if the difference between the values in duration fields in RTS and CTS is equal to CTS plus SIFS. If it is not, then the initiator knows that responder has data to transmit. If the difference, minus (CTS+SIFS), is less than the remaining TXOP, when the initiator transmits its data, the initiator will also send a grant to the responder, granting permission for the responder to transmit its data. The data from the responder can be piggybacked (concatenated) with the BA the responder sends upon receipt of the initiator's data.

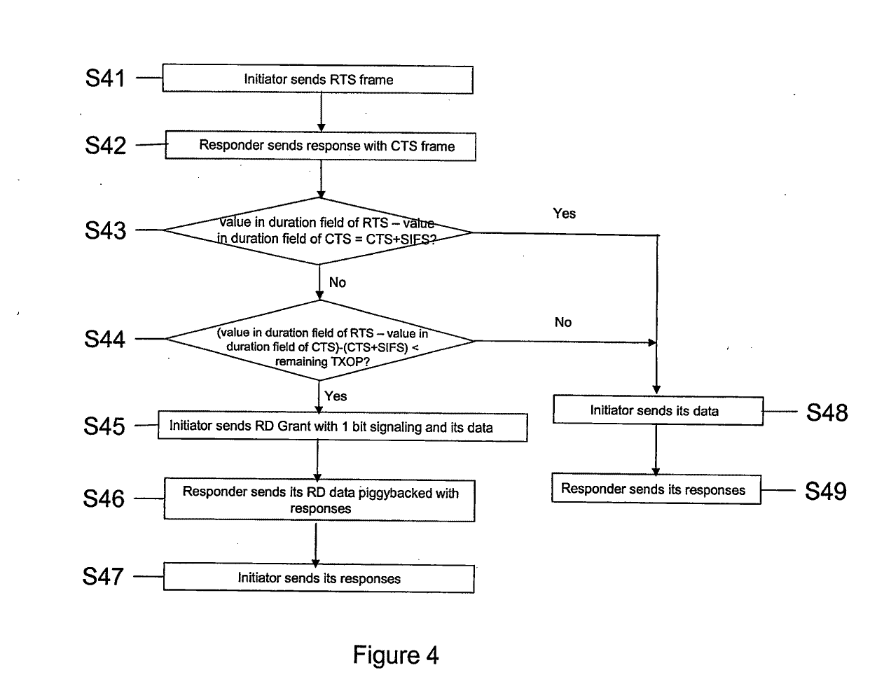

FIG. 4 is a flow chart corresponding to the timing chart of FIG. 3. The process begins when the initiator sends an RTS frame (S41). The responder sends a response with a CTS frame (S42). The initiator determines if the value in the duration field of the RTS minus the value in the duration field of CTS equals CTS+SIFS (S43). If “yes,” the initiator sends its data (S48) followed by the responder sending its responses (S49). However, if step S43 results in a “no,” the initiator next determines if the value in the duration field of the RTS minus the value of the duration field of the CTS minus (CTS+SIFS) is less than the remaining TXOP (S44). If step S44 results in “no,” steps S48 and S49 are completed as previously described. If step S44 results in a “yes,” the initiator sends a RD grant with a 1 bit signal along with its data (S45). The responder then sends its RD data piggybacked with its responses (S46). Afterwards, the initiator sends its response (S47).

Due to the modification of duration value in CTS associated with the embodiment described in FIGS. 3-4, the initiator's TXOP may not be protected from hidden nodes. That is, hidden nodes may transmit during the portion of the TXOP that the initiator gives to the responder, thus causes a collision. Generally, the duration value in CTS, t₂, extends beyond a critical time, t_{c}, corresponding to the end of the responder's BA transmission. In other words, responder will transmit BA and reverse data before the unprotected period begins. Hence, the STAs will update their NAV upon receipt of BA and data. If the requested reverse data duration, d₁, is not less than remaining TXOP, then initiator rejects the request anyway. However, there is still some possibility of unprotected period if next BA or data are not received correctly by STAs.

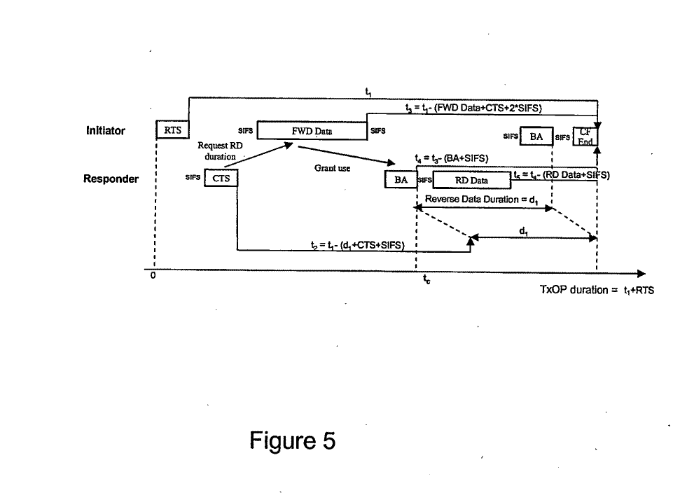

The Reverse Direction (RD) data duration in CTS is decided upon the receipt of RTS from initiator that includes only the address of initiator and the duration of TXOP. Therefore, there is no indication in RTS to show which AC the data from initiator belongs to. The responder has to wait until the reception of the data packet from the initiator to know that the AC of the data that has been sent. By the rule of not violating the TXOP usage, the AC of RD data should be the same as the AC of the data from initiator. So, there is some concern that the responder may not have enough time to pack a data unit with the same AC to transmit. The solution is to insert an SIFS interval between the responder's BA and data as shown in FIG. 5. The SIFS gives the responder enough time to identify the necessary frames for RD transmission.

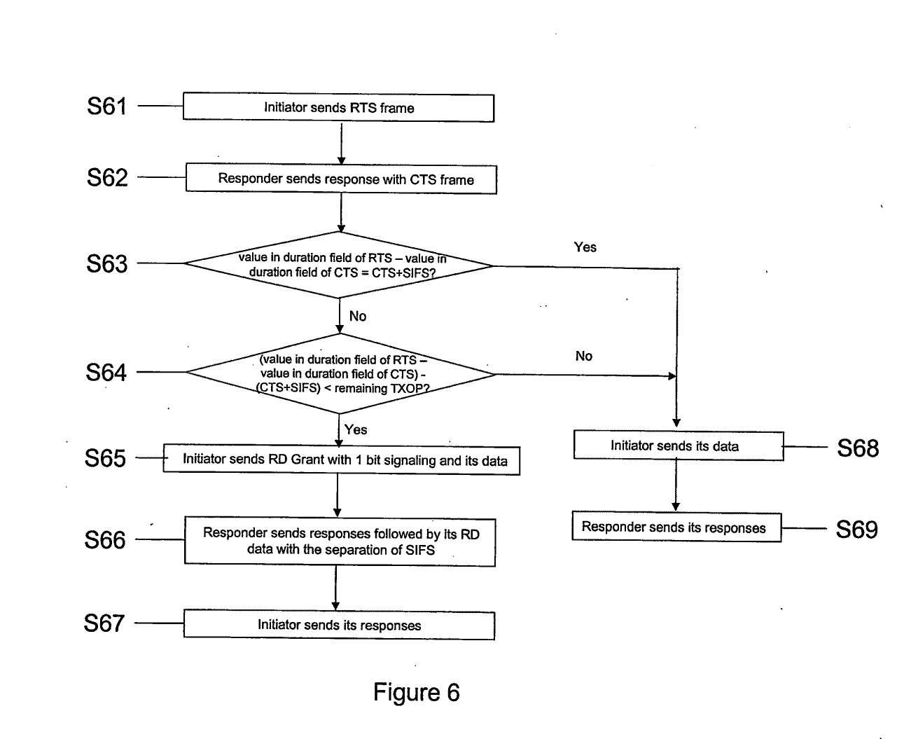

FIG. 6 is a flow chart corresponding to the timing chart of FIG. 5. Steps S61-S65 and S67-S69 are identical to previously described Steps S41-S45 and S47-S49. However, rather than responder sending its RD data piggybacked with its responses as described with respect to step S46, in this embodiment, the responder sends its responses followed by its RD data with a separation of SIFS (S66).

In alternative embodiments, the responder does not include a request for permission to transmit in/with the CTS signal. Instead, the initiator merely grants any remaining time in the initiator's TxOP to the responder, granting permission for the responder to transmit its data. The data from the responder can be piggybacked (concatenated) with the BA the responder sends upon receipt of the initiator's data. Alternatively, the data from responder can be separated from the BA the responder sends upon receipt of the initiator's data.

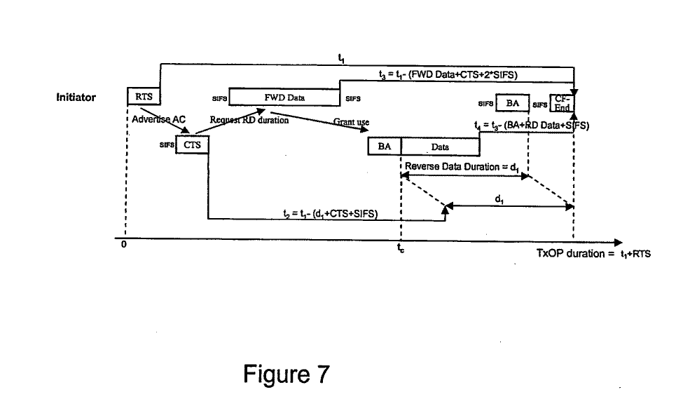

While the embodiment of FIGS. 5-6 solves one problem, this embodiment introduces extra overhead for RD transmission since it inserts SIFS between BA and RD Data. Another method to address the issue is shown in FIG. 7. In this embodiment, the initiator advertises AC in the RTS frame to the responder. By alerting the responder of the AC type in the RTS frame (rather than waiting for the responder to discover the AC type when the forward data is received) more time is provided to the responder to format the data in the proper AC type.

This embodiment takes advantage of the fact that there are 7 unused reserved bits in Frame Control field of RTS. Since there are total 4 ACs available, one variant to choose 2 bits of the unused bits to advertise the AC of the data from initiator. In other variants, additional bits can be used. With the bits properly selected, the responder will be able to identify the AC of the data from initiator from RTS frame at the very beginning. Thus, the responder will have enough time to pack the RD data with the same AC type before transmission. Therefore, this embodiment provides the same benefits as the embodiment shown in FIG. 5 without requiring the use of a SIFS between BA and RD data.

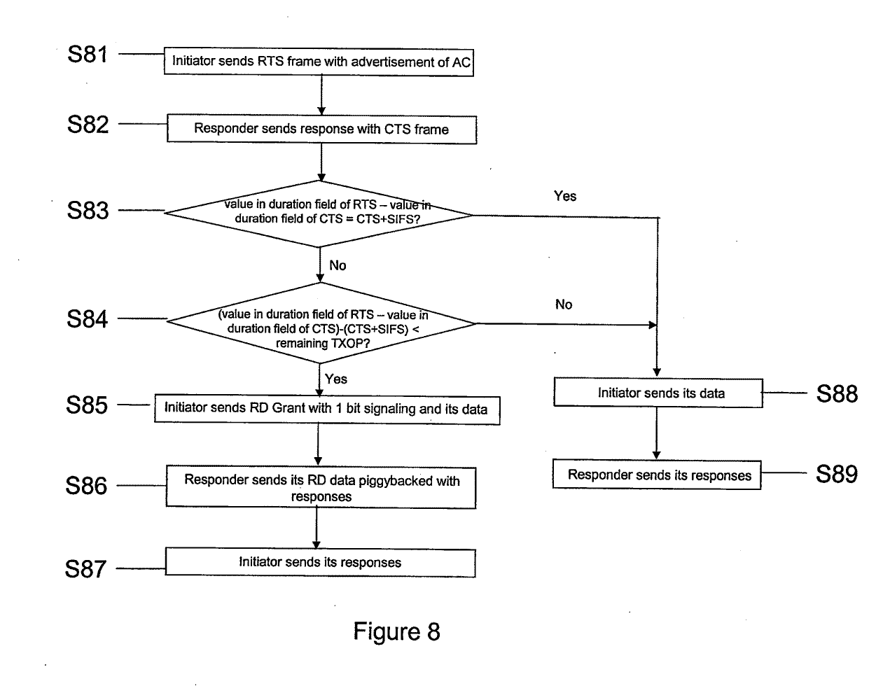

FIG. 8 is a flow chart corresponding to the timing chart of FIG. 7. Steps S82-S89 are identical to Steps S42-S49. However, unlike the method of FIG. 4 which begins in Step S41 with the initiator sending only an RTS frame, this method begins with the initiator sending an RTS frame with an advertisement of AC (S81).

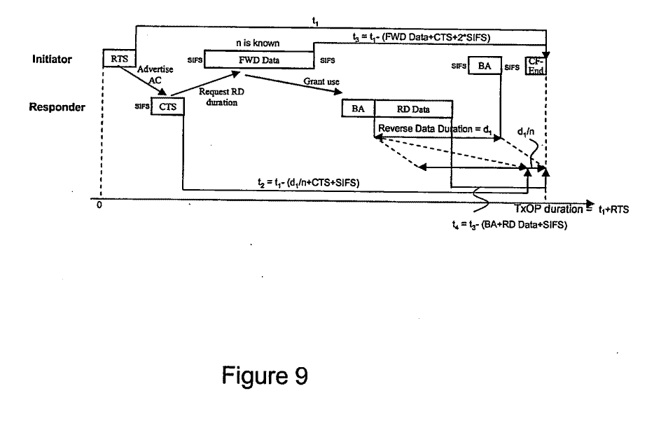

As discussed previously, duration value in the CTS from responder does not reflect the real NAV duration stated in the legacy IEEE 802 standard. First, the NAVs that are set by the CTS are updated by the upcoming frames from the responder. Secondly, the STAs which received the RTS from the initiator will not update their NAVs because the new duration values in both CTS and upcoming frames from responder are smaller than the previous one. This is true for STAs within the same BSS. The present inventors have discovered that it is better to have a smaller unprotected period for overlapping BSSs in case the frames following the CTS are erroneous. Hence, in the embodiment shown in FIG. 9, d₁/n is used instead of d₁ in the CTS duration field. Both the responder and the initiator know the value of n in advance, so the initiator can easily calculate exact duration request by multiplying the difference by n. This reduces the unprotected period in case the BA or RD data are not received by STAs.

Granting RD transmission can be done through one bit signaling in data or BAR (Block Ack Request) from the initiator. One bit in the QoS control field in the data frame can be used for this purpose with the one bit set to 1 for grant and 0 for rejection. In the upcoming IEEE 802.11e standard protocol, Bit 7 is unused in the QoS control field in a data frame. Thus, in one variant, bit 7 can be used to identify grant or rejection. Alternatively, it is possible to use a new QoS data subtype called QoS Data+Request-AccepteD (RAD). In this alternative, the frame control field, if b3b2 is set to 10, the frame control field indicates QoS data. A 1101 value of b7b6b5b4 is reserved in IEEE 802.11e standard protocol. Thus, this variant uses for RAD.

In yet another variant, one may use the BAR frame for indicating grant or rejection to the responder. The first 12 bits in the BAR control field have been reserved in IEEE 802.11e standard. Thus, one of these bits can be used for signaling purposes. Also, there are 7 bits that are not used in the frame control field in the BAR frame so, in yet another variant, at least one of these 7 bits can be used for this signaling purpose. For example, the “Order” bit can be used for this purpose.

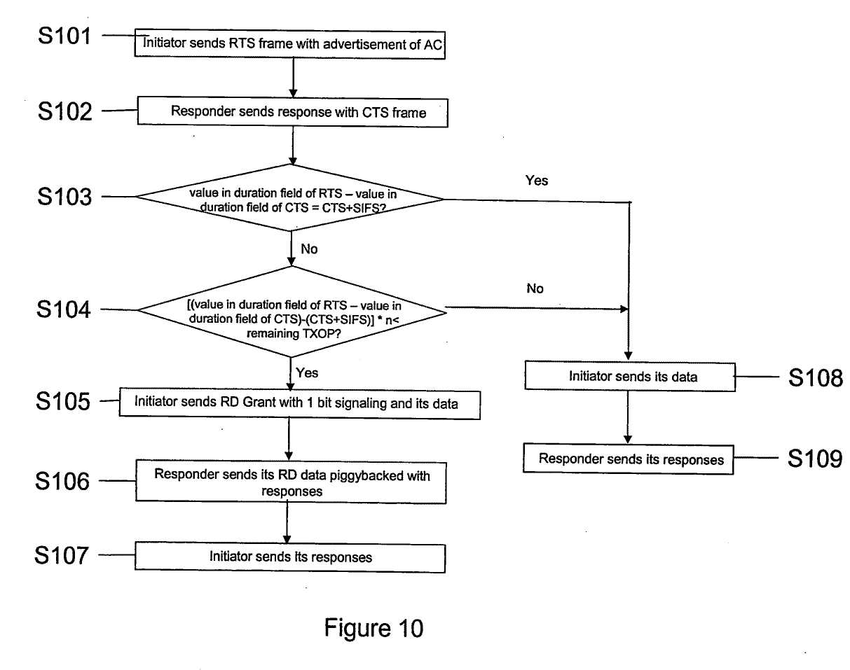

FIG. 10 is flow chart corresponding to the timing chart of FIG. 9. Steps S101-S103 and S105-S109 are identical to Steps S81-S83 and S85-S89. However, rather than determining whether the value in the duration field of the RTS minus the value of the duration field of the CTS minus (CTS+FIFS) is less than the remaining TXOP as described in S84, in Step S104 the initiator determines whether [the value in the duration field of the RTS minus the value in the duration field of the CTS minus (CTS+FIFS)] times the value (n) is less than the remaining TXOP.

For each of the embodiments, and all the variants therein, the reverse direction protocol does not require any change in existing hardware. Thus, reverse direction communications can be achieved much more easily as the previously described embodiments only require software changes regarding the use of existing control frames. Also, performance is enhanced relative to existing protocols, with improved flexibility and simplicity in terms of the flow control.

In summary, the present invention is directed to a novel reverse direction protocol to transfer data in reverse direction without initiating a new medium access contention procedure by a responder. The invention allows a responder to aggregate its data in the reverse direction in response to an initiating station transmission. This scheme eliminates the channel contention time incurred by conventional protocols and procedures. The invention also minimizes turnaround times between the initiator and the responder while ensuring channel protection.

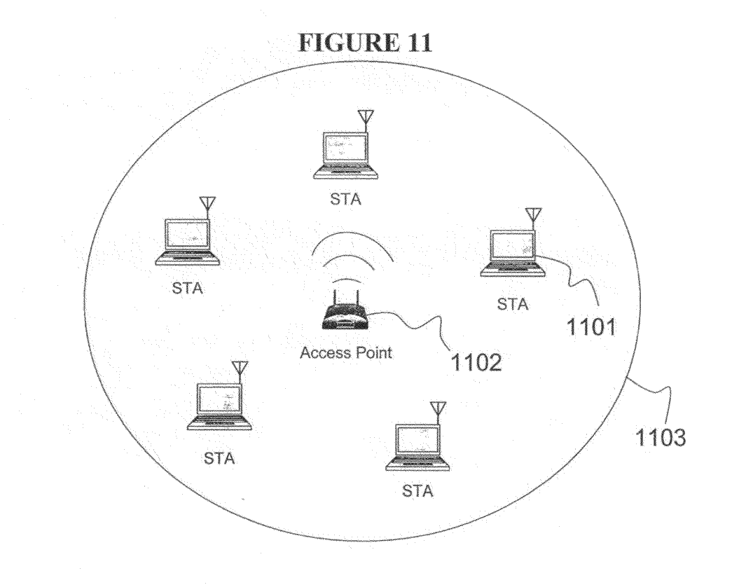

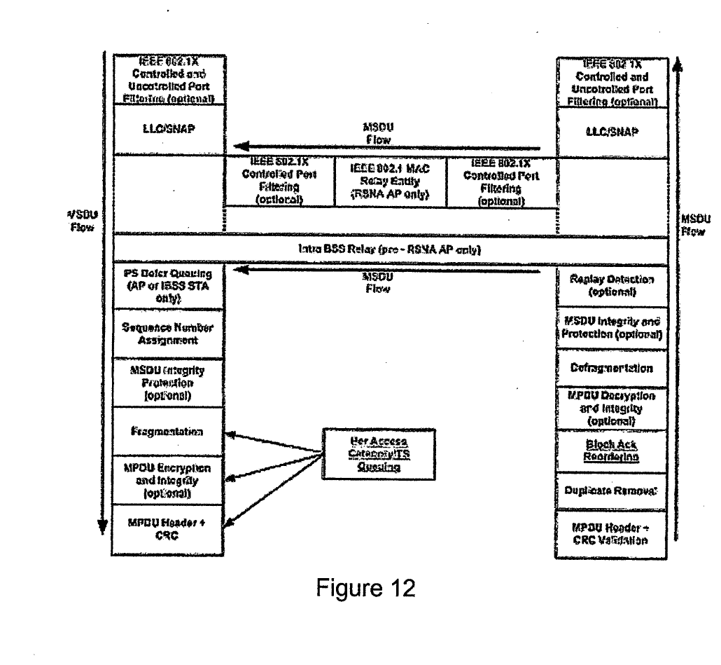

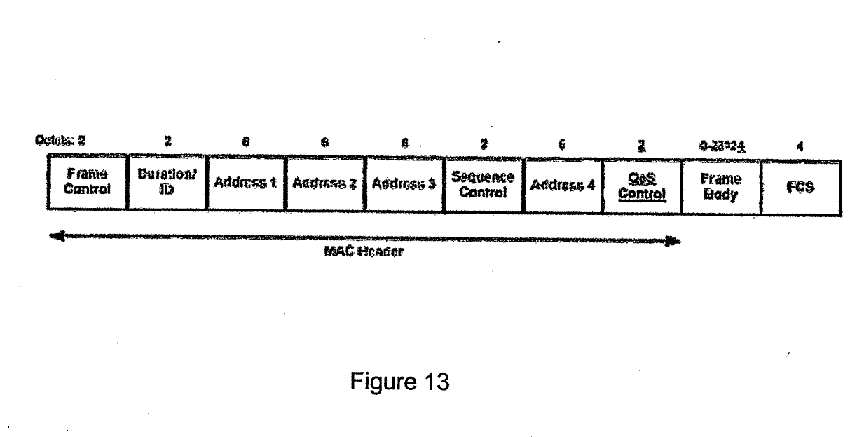

FIG. 11 is an illustration of a wireless network on which the previously described protocols are designed to work. The network includes a plurality of stations 1101 within a wireless coverage zone 1103 of an access point 1102. The previously described methods are implemented in software designed to run on a MAC layer as shown in FIG. 12. A MAC header associated with the present invention is shown in FIG. 13. The previously described methods are preferably implemented in C/C++ language which is written into a ROM (Read Only Memory) of a station 1101 and access point 1102. Alternative languages and storage implementations are possible. The method may also be adapted for wired network use.

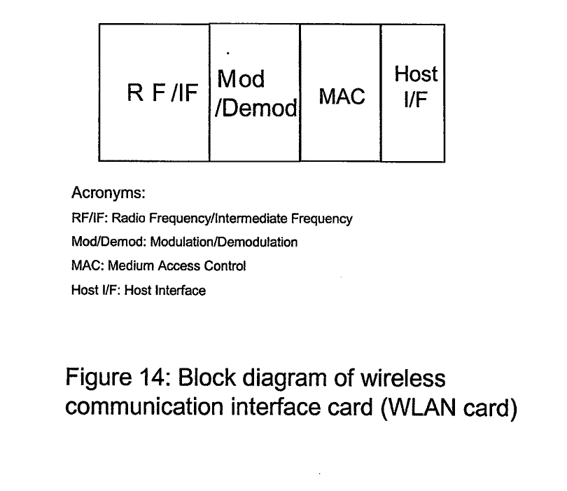

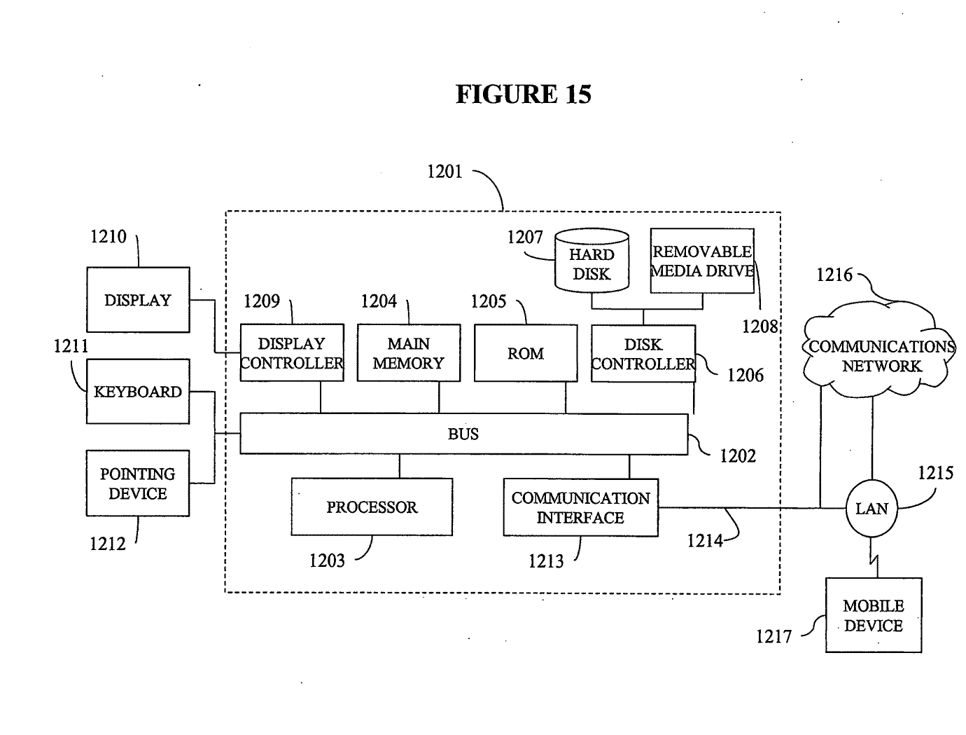

FIG. 14 is a simplified block diagram of a WLAN card used with the present invention. The present invention is related to the MAC layer function of communication interface particularly a WLAN card. That is, the component 1213 in FIG. 15, discussed below. The present invention is the enhancement of MAC and may be implemented entirely in software. MAC software corresponding to the present invention may be written into a ROM on a WLAN card.

FIG. 15 illustrates a computer system 1201 upon which an embodiment of the present invention may be implemented. The computer system 1201 includes a bus 1202 or other communication mechanism for communicating information, and a processor 1203 coupled with the bus 1202 for processing the information. The computer system 1201 also includes a main memory 1204, such as a random access memory (RAM) or other dynamic storage device (e.g., dynamic RAM (DRAM), static RAM (SRAM), and synchronous DRAM (SDRAM)), coupled to the bus 1202 for storing information and instructions to be executed by processor 1203. In addition, the main memory 1204 may be used for storing temporary variables or other intermediate information during the execution of instructions by the processor 1203. The computer system 1201 further includes a read only memory (ROM) 1205 or other static storage device (e.g., programmable ROM (PROM), erasable PROM (EPROM), and electrically erasable PROM (EEPROM)) coupled to the bus 1202 for storing static information and instructions for the processor 1203.

The computer system 1201 also includes a disk controller 1206 coupled to the bus 1202 to control one or more storage devices for storing information and instructions, such as a magnetic hard disk 1207, and a removable media drive 1208 (e.g., floppy disk drive, read-only compact disc drive, read/write compact disc drive, compact disc jukebox, tape drive, and removable magneto-optical drive). The storage devices may be added to the computer system 1201 using an appropriate device interface (e.g., small computer system interface (SCSI), integrated device electronics (IDE), enhanced-IDE (E-IDE), direct memory access (DMA), or ultra-DMA).

The computer system 1201 may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)).

The computer system 1201 may also include a display controller 1209 coupled to the bus 1202 to control a display 1210, such as a cathode ray tube (CRT), for displaying information to a computer user. The computer system includes input devices, such as a keyboard 1211 and a pointing device 1212, for interacting with a computer user and providing information to the processor 1203. The pointing device 1212, for example, may be a mouse, a trackball, or a pointing stick for communicating direction information and command selections to the processor 1203 and for controlling cursor movement on the display 1210. In addition, a printer may provide printed listings of data stored and/or generated by the computer system 1201.

The computer system 1201 performs a portion or all of the processing steps of the invention in response to the processor 1203 executing one or more sequences of one or more instructions contained in a memory, such as the main memory 1204. Such instructions may be read into the main memory 1204 from another computer readable medium, such as a hard disk 1207 or a removable media drive 1208. One or more processors in a multi-processing arrangement may also be employed to execute the sequences of instructions contained in main memory 1204. In alternative embodiments, hard-wired circuitry may be used in place of or in combination with software instructions. Thus, embodiments are not limited to any specific combination of hardware circuitry and software.

As stated above, the computer system 1201 includes at least one computer readable medium or memory for holding instructions programmed according to the teachings of the invention and for containing data structures, tables, records, or other data described herein. Examples of computer readable media are compact discs, hard disks, floppy disks, tape, magneto-optical disks, PROMs (EPROM, EEPROM, flash EPROM), DRAM, SRAM, SDRAM, or any other magnetic medium, compact discs (e.g., CD-ROM), or any other optical medium, punch cards, paper tape, or other physical medium with patterns of holes, a carrier wave (described below), or any other medium from which a computer can read.

Stored on any one or on a combination of computer readable media, the present invention includes software for controlling the computer system 1201, for driving a device or devices for implementing the invention, and for enabling the computer system 1201 to interact with a human user (e.g., print production personnel). Such software may include, but is not limited to, device drivers, operating systems, development tools, and applications software. Such computer readable media further includes the computer program product of the present invention for performing all or a portion (if processing is distributed) of the processing performed in implementing the invention.

The computer code devices of the present invention may be any interpretable or executable code mechanism, including but not limited to scripts, interpretable programs, dynamic link libraries (DLLs), Java classes, and complete executable programs. Moreover, parts of the processing of the present invention may be distributed for better performance, reliability, and/or cost.

The term “computer readable medium” as used herein refers to any medium that participates in providing instructions to the processor 1203 for execution. A computer readable medium may take many forms, including but not limited to, non-volatile media, volatile media, and transmission media. Non-volatile media includes, for example, optical, magnetic disks, and magneto-optical disks, such as the hard disk 1207 or the removable media drive 1208. Volatile media includes dynamic memory, such as the main memory 1204. Transmission media includes coaxial cables, copper wire and fiber optics, including the wires that make up the bus 1202. Transmission media also may also take the form of acoustic or light waves, such as those generated during radio wave and infrared data communications.

Various forms of computer readable media may be involved in carrying out one or more sequences of one or more instructions to processor 1203 for execution. For example, the instructions may initially be carried on a magnetic disk of a remote computer. The remote computer can load the instructions for implementing all or a portion of the present invention remotely into a dynamic memory and send the instructions over a telephone line using a modem. A modem local to the computer system 1201 may receive the data on the telephone line and use an infrared transmitter to convert the data to an infrared signal. An infrared detector coupled to the bus 1202 can receive the data carried in the infrared signal and place the data on the bus 1202. The bus 1202 carries the data to the main memory 1204, from which the processor 1203 retrieves and executes the instructions. The instructions received by the main memory 1204 may optionally be stored on storage device 1207 or 1208 either before or after execution by processor 1203.

The computer system 1201 also includes a communication interface 1213 coupled to the bus 1202. The communication interface 1213 provides a two-way data communication coupling to a network link 1214 that is connected to, for example, a local area network (LAN) 1215, or to another communications network 1216 such as the Internet. For example, the communication interface 1213 may be a network interface card to attach to any packet switched LAN. As another example, the communication interface 1213 may be an asymmetrical digital subscriber line (ADSL) card, an integrated services digital network (ISDN) card or a modem to provide a data communication connection to a corresponding type of communications line. Wireless links may also be implemented. In any such implementation, the communication interface 1213 sends and receives electrical, electromagnetic or optical signals that carry digital data streams representing various types of information.

The network link 1214 typically provides data communication through one or more networks to other data devices. For example, the network link 1214 may provide a connection to another computer through a local network 1215 (e.g., a LAN) or through equipment operated by a service provider, which provides communication services through a communications network 1216. The local network 1214 and the communications network 1216 use, for example, electrical, electromagnetic, or optical signals that carry digital data streams, and the associated physical layer (e.g., CAT 5 cable, coaxial cable, optical fiber, etc). The signals through the various networks and the signals on the network link 1214 and through the communication interface 1213, which carry the digital data to and from the computer system 1201 maybe implemented in baseband signals, or carrier wave based signals. The baseband signals convey the digital data as unmodulated electrical pulses that are descriptive of a stream of digital data bits, where the term “bits” is to be construed broadly to mean symbol, where each symbol conveys at least one or more information bits. The digital data may also be used to modulate a carrier wave, such as with amplitude, phase and/or frequency shift keyed signals that are propagated over a conductive media, or transmitted as electromagnetic waves through a propagation medium. Thus, the digital data may be sent as unmodulated baseband data through a “wired” communication channel and/or sent within a predetermined frequency band, different than baseband, by modulating a carrier wave. The computer system 1201 can transmit and receive data, including program code, through the network(s) 1215 and 1216, the network link 1214 and the communication interface 1213. Moreover, the network link 1214 may provide a connection through a LAN 1215 to a mobile device 1217 such as a personal digital assistant (PDA) laptop computer, or cellular telephone.

We claim:

1. A method for wireless communication between an initiator station and a responder station, said method comprising:
assigning a transmit window having a predefined window duration to the initiator;
sending a request-to-send signal from the initiator to the responder;
sending a clear-to-send signal from the responder to the initiator; and
sending forward data and a reverse transmission permission from the initiator to the responder, said reverse transmission permission granting said responder permission to transmit during said transmit window.

2. The method of claim 1, further comprising:
sending a request for reverse transmission with said clear-to-send signal.

3. The method of claim 2, wherein said step of sending a request for reverse transmission comprises:
sending a reverse transmission duration period from the responder to the initiator with said clear-to-send signal.

4. The method of claim 3, further comprising:
evaluating whether said reverse transmission duration period can be accommodated in a remaining portion of said transmission window.

5. The method of claim 4, wherein said step of evaluating comprises:
determining whether a difference between a duration of said forward data and said reverse transmission duration period equals a predetermined value.

6. The method of claim 5, further comprising:
sending reverse data from the responder to the initiator when said difference does not equal said predetermined value.

7. The method of claim 6, further comprising:
sending an acknowledgement of forward data receipt from the responder to the initiator; and
sending a clear signal from the initiator, said clear signal indicating the initiator relinquishes said transmit window.

8. The method of claim 1, further comprising:
sending an acknowledgement of forward data receipt from the responder to the initiator.

9. The method of claim 8, further comprising:
sending reverse data from the responder to the initiator, wherein said acknowledgement of forward data receipt and said reverse data are concatenated.

10. The method of claim 8, further comprising:
sending reverse data from the responder to the initiator, wherein said acknowledgement of forward data receipt and said reverse data are separated by a predetermined interval.

11. The method of claim 10, wherein said predetermined interval corresponds to a short interframe space.

12. The method of claim 1, wherein said step of sending a request-to-send signal from the initiator to the responder comprises:
advertising an AC (Access Category) to said responder.

13. The method of claim 12, wherein said step of advertising comprises:
signaling said AC (Access Category) with 2 bits.

14. The method of claim 12, further comprising:
formatting reverse data in accordance with said AC (Access Category); and
sending said reverse data from the responder to the initiator.

15. The method of claim 5, further comprising:
scaling said reverse transmission duration period by a scaling factor greater than zero and less than 1.

16. The method of claim 15, further comprising:
sending scaled reverse data from the responder to the initiator when said difference does not equal said predetermined value.

17. A method for wireless communication between an initiator station and a responder station, wherein a transmit window having a predefined window duration is assigned to the initiator, said method comprising:
sending a request-to-send signal from the initiator to the responder;
receiving at the initiator a clear-to-send signal; and
sending forward data and a reverse transmission permission from the initiator to the responder, said reverse transmission permission granting said responder permission to transmit during said transmit window.

18. The method of claim 17, further comprising:
determining whether a request for reverse transmission is sent with said clear-to-send signal.

19. The method of claim 17, wherein said step of determining whether a request for reverse transmission is sent comprises:
determining whether a reverse transmission duration period is sent with said clear-to-send signal.

20. The method of claim 19, further comprising:
evaluating whether a reverse transmission duration period can be accommodated within a remaining portion of said transmission window.

21. The method of claim 20 wherein said step of evaluating comprises:
determining whether a difference between a duration of said forward data and said reverse data transmission duration period equals a predetermined value.

22. The method of claim 21, further comprising:
receiving reverse data from the responder within said transmit window assigned to said initiator when said difference does not equal said predetermined value.

23. The method of claim 22, further comprising:
sending an acknowledgement of reverse data receipt from the initiator to the responder; and
sending a clear signal from the initiator, said clear signal indicating the initiator relinquishes said transmit window.

24. The method of claim 18, further comprising:
receiving at the initiator an acknowledgement of forward data receipt from the responder; and
receiving reverse data from the responder within said transmit window assigned to said initiator when said difference does not equal said predetermined value.

25. The method of claim 24, wherein said acknowledgement of forward data receipt and said reverse data are concatenated.

26. The method of claim 24, wherein said acknowledgement of forward data receipt and said reverse data are separated by a predetermined interval.

27. The method of claim 26, wherein said predetermined interval corresponds to a short interframe space.

28. The method of claim 17, wherein said step of sending a request-to-send signal from the initiator to the responder comprises:
advertising an AC (Access Category) to said responder.

29. The method of claim 28, wherein said step of advertising comprises:
signaling said AC (Access Category) with 2 bits.

30. The method of claim 21, further comprising:
receiving scaled reverse data from the responder when said difference does not equal said predetermined value.

31. The method of claim 30, wherein a duration of said scaled reverse data equals said reverse transmission duration period multiplied by a scaling factor greater than zero and less than 1.

32. A method for wireless communication between an initiator station and a responder station, said initiator being assigned a transmit window having a predefined window duration, said method comprising:
receiving at the responder a request-to-send signal from the initiator;
sending a clear-to-send signal from the responder to the initiator; and
receiving at the responder forward data and a reverse transmission permission from the initiator, said reverse transmission permission granting said responder permission to transmit during said transmit window.

33. The method of claim 32, further comprising:
sending a reverse transmission request with said clear-to-send signal.

34. The method of claim 33, wherein said step of sending a reverse transmission request comprises:
sending a reverse transmission duration period with said clear-to-send signal.

35. The method of claim 34, wherein said reverse transmission duration period can be accommodated within a remaining portion of said transmission window.

36. The method of claim 35, further comprising:
sending reverse data to the initiator within said transmission window when a difference between a duration of said forward data and said reverse transmission duration period is not equal to a predetermined value.

37. The method of claim 36, further comprising:
receiving from the initiator an acknowledgement of reverse data receipt at the responder.

38. The method of claim 32, further comprising:
sending to the initiator an acknowledgement of forward data receipt from the responder.

39. The method of claim 38, further comprising:
sending reverse data to the initiator within said transmit window assigned to the initiator, wherein said acknowledgement of forward data receipt and said reverse data are concatenated.

40. The method of claim 38, further comprising:
sending reverse data to the initiator within said transmit window assigned to the initiator, wherein said acknowledgement of forward data receipt and said reverse data are separated by a predetermined interval.

41. The method of claim 40, wherein said predetermined interval corresponds to a short interframe space.

42. The method of claim 32, wherein said step of receiving a request-to-send signal from the initiator comprises:
receiving an advertisement for an AC (Access Category) from said initiator.

43. The method of claim 42, wherein said step of receiving an advertisement comprises:
receiving 2 bits corresponding to said AC (Access Category).

44. The method of claim 42, further comprising:
formatting reverse data in accordance with said AC (Access Category); and
sending said reverse data to the initiator within said transmission window when a reverse transmission duration period can be accommodated within a remaining portion of said transmit window.

45. The method of claim 35, further comprising:
scaling said reverse transmission duration period by a scaling factor greater than zero and less than 1.

46. The method of claim 45, further comprising:
sending scaled reverse data from the responder to the initiator when said difference does not equal said predetermined value.

47. A system configured for wireless communication between an initiator station and a responder station, said system comprising:
means for assigning a transmit window having a predefined window duration to the initiator;
means for sending a request-to-send signal from the initiator to the responder;
means for sending a clear-to-send signal from the responder to the initiator; and
means for sending forward data and a reverse transmission permission from the initiator to the responder, said reverse transmission permission granting said responder permission to transmit during said transmit window.

48. The system of claim 47, further comprising:
means for sending a request for reverse transmission with said clear-to-send signal.

49. The system of claim 47, wherein said means for sending a request for reverse transmission comprises:
means for sending a reverse transmission duration period from the responder to the initiator with said clear-to-send signal.

50. The system of claim 49, further comprising:
means for evaluating whether said reverse transmission period can be accommodated within a remaining portion of said transmission window.

51. The system of claim 50, wherein said means for evaluating comprises:
means for determining whether a difference between a duration of said forward data and said reverse transmission duration period equals a predetermined value.

52. The system of claim 51, further comprising:
means for sending reverse data from the responder to the initiator within said transmit window assigned to the initiator when said difference does not equal said predetermined value.

53. The system of claim 52, further comprising:
means for sending an acknowledgement of reverse data receipt from the initiator to the responder; and
means for sending a clear signal from the initiator, said clear signal indicating the initiator relinquishes said transmit window.

54. The system of claim 47, further comprising:
means for sending an acknowledgement of forward data receipt from the responder to the initiator.

55. The system of claim 54, further comprising:
means for sending reverse data from the responder to the initiator within said transmit window assigned to the initiator, wherein said acknowledgement of forward data receipt and said reverse data are concatenated.

56. The system of claim 54, further comprising:
means for sending reverse data from the responder to the initiator within said transmit window assigned to the initiator, wherein said acknowledgement of forward data receipt and said reverse data are separated by a predetermined interval.

57. The system of claim 56, wherein said predetermined interval corresponds to a short interframe space.

58. The system of claim 47, wherein said means for sending a request-to-send signal from the initiator to the responder comprises:
means for advertising an AC (Access Category) to said responder.

59. The system of claim 58, wherein said means for advertising comprises:
means for signaling said AC (Access Category) with 2 bits.

60. The system of claim 58, further comprising:
means for receiving reverse data from said responder within said transmit window; and
means for formatting said reverse data in accordance with said AC (Access Category).

61. The system of claim 51, further comprising:
means for scaling said reverse transmission duration period by a scaling factor greater than zero and less than 1.

62. The system of claim 61, further comprising:
means for sending scaled reverse data from the responder to the initiator when said difference does not equal said predetermined value.

63. An initiator station for wireless communication with a responder station, wherein a transmit window having a predefined window duration is assigned to the initiator station, said initiator system comprising:
means for sending a request-to-send signal from the initiator to the responder;
means for receiving at the initiator a clear-to-send signal; and
means for sending forward data and a reverse transmission permission from the initiator to the responder, said reverse transmission permission granting said responder permission to transmit during said transmit window.

64. The initiator station of claim 63, further comprising:
means for receiving a request for reverse transmission with said clear-to-send signal.

65. The initiator station of claim 63, wherein said means for receiving a request for reverse transmission comprises:
means for receiving a reverse transmission duration period from the responder with said clear-to-send signal.

66. The initiator station of claim 65, further comprising:
means for evaluating whether said reverse transmission duration period can be accommodated within a remaining portion of said transmission window.

67. The initiator station of claim 66 whether a difference between a duration of said forward data and said reverse transmission duration period is equal to a predetermined value.

68. The initiator station of claim 67, further comprising:
means for receiving reverse data from the responder when said difference does not equal said predetermined value.

69. The initiator station of claim 68, further comprising:
means for sending an acknowledgement of reverse data receipt from the initiator to the responder; and
means for sending a clear signal from the initiator, said clear signal indicating the initiator relinquishes said transmit window.

70. The initiator station of claim 63, further comprising:
means for receiving at the initiator an acknowledgement of forward data receipt from the responder; and
means for receiving reverse data from said responder.

71. The initiator station of claim 70, wherein said acknowledgement of forward data receipt and said reverse data are concatenated.

72. The initiator station of claim 70, wherein said acknowledgement of forward data receipt and said reverse data are separated by a predetermined interval.

73. The initiator station of claim 72, wherein said predetermined interval corresponds to a short interframe space.

74. The initiator station of claim 63, wherein said means for sending a request-to-send signal from the initiator to the responder comprises:
means for advertising an AC (Access Category) to said responder.

75. The initiator station of claim 74, wherein said means for advertising comprises:
means for signaling said AC (Access Category) with 2 bits.

76. The initiator station of claim 67, further comprising:
means for receiving scaled reverse data from the responder when said difference does not equal said predetermined value.

77. The initiator station of claim 76, wherein a duration of said scaled reverse data equals said reverse transmission duration period multiplied by a scaling factor greater than zero and less than 1.

78. A responder station configured for wireless communication with an initiator station, said initiator station being assigned a transmit window having a predefined window duration, said responder station comprising:
means for receiving at the responder a request-to-send signal from the initiator;
means for sending a clear-to-send signal from the responder to the initiator; and
means for receiving at the responder forward data and a reverse transmission permission from the initiator, said reverse transmission permission granting said responder permission to transmit during said transmit window.

79. The responder station of claim 78, further comprising:
means for sending a reverse transmission request including a reverse transmission duration period from the responder to the initiator with said clear-to-send signal.

80. The responder station of claim 79, wherein said reverse transmission duration period can be accommodated within said transmit window.

81. The responder station of claim 80, wherein a difference between a duration of said forward data and said reverse transmission duration period is equal to a predetermined value.

82. The responder station of claim 81, further comprising:
means for sending reverse data from the responder to the initiator within said transmit window assigned to the initiator when said difference is not equal to said predetermined value.

83. The responder station of claim 82, further comprising:
means for receiving from the initiator an acknowledgement of reverse data receipt at the responder.

84. The responder station of claim 78, further comprising at least one of:
means for sending to the initiator an acknowledgement of forward data receipt from the responder; and
means for sending reverse data to the initiator within said transmit window assigned to the initiator.

85. The responder station of claim 84, wherein said acknowledgement of forward data receipt and said reverse data are concatenated.

86. The responder station of claim 84, wherein said acknowledgement of forward data receipt and said reverse data are separated by a predetermined interval.

87. The responder station of claim 86, wherein said predetermined interval corresponds to a short interframe space.

88. The responder station of claim 78, wherein said means for receiving a request-to-send signal from the initiator comprises:
means for receiving an advertisement for an AC (Access Category) from said initiator.

89. The responder station of claim 88, wherein said means for receiving an advertisement comprises:
means for receiving 2 bits corresponding to said AC (Access Category).

90. The responder station of claim 88, further comprising:
means for formatting reverse data in accordance with said AC (Access Category); and
means for sending formatted reverse data to said initiator within said transmit window assigned to said initiator.

91. The responder station of claim 81, further comprising:
means for scaling said reverse transmission duration period by a scaling factor greater than zero and less than 1.

92. The responder station of claim 91, further comprising:
means for sending scaled reverse data from the responder to the initiator when said difference does not equal said predetermined value.

93. A computer program product for wireless communication between an initiator station and a responder station, said computer program product comprising instructions for:
assigning a transmit window having a predefined window duration to the initiator;
sending a request-to-send signal from the initiator to the responder;
sending a clear-to-send signal from the responder to the initiator; and
sending forward data and a reverse transmission permission from the initiator to the responder, said reverse transmission permission granting said responder permission to transmit during said transmit window.

94. The computer program product of claim 93, further comprising instructions for:
sending a request for reverse transmission with said clear-to-send signal.

95. The computer program product of claim 93, further comprising instructions for:
sending a reverse transmission duration period from the responder to the initiator with said clear-to-send signal.

96. The computer program product of claim 95, further comprising instructions for:
evaluating whether said reverse transmission duration period can be accommodated in a remaining portion of said transmission window.

97. The computer program product of claim 96, further comprising instructions for:
determining whether a difference between a duration of said forward data and said reverse transmission duration period equals a predetermined value.

98. The computer program product of claim 97, further comprising instructions for:
sending reverse data from the responder to the initiator when said difference does not equal said predetermined value.

99. The computer program product of claim 98, further comprising instructions for:
sending an acknowledgement of forward data receipt from the responder to the initiator; and
sending a clear signal from the initiator, said clear signal indicating the initiator relinquishes said transmit window.

100. The computer program product of claim 93, further comprising instructions for:
sending an acknowledgement of forward data receipt from the responder to the initiator.

101. The computer program product of claim 100, further comprising instructions for:
sending reverse data from the responder to the initiator, wherein said acknowledgement of forward data receipt and said reverse data are concatenated.

102. The computer program product of claim 100, further comprising instructions for:
sending reverse data from the responder to the initiator, wherein said acknowledgement of forward data receipt and said reverse data are separated by a predetermined interval.

103. The computer program product of claim 102, wherein said predetermined interval corresponds to a short interframe space.

104. The computer program product of claim 93, further comprising instructions for:
advertising an AC (Access Category) to said responder.

105. The computer program product of claim 104, wherein said instructions for advertising comprise instructions for:
signaling said AC (Access Category) with 2 bits.

106. The computer program product of claim 104, further comprising instructions for:
formatting reverse data in accordance with said AC (Access Category); and
sending said reverse data from the responder to the initiator.

107. The computer program product of claim 97, further comprising instructions for:
scaling said reverse transmission duration period by a scaling factor greater than zero and less than 1.

108. The computer program product of claim 107, further comprising instructions for:
sending scaled reverse data from the responder to the initiator when said difference does not equal said predetermined value.

109. A computer program product for wireless communication between an initiator station and a responder station, wherein a transmit window having a predefined window duration is assigned to the initiator, said computer program product comprising instructions for:
sending a request-to-send signal from the initiator to the responder;
receiving at the initiator a clear-to-send signal; and
sending forward data and a reverse transmission permission from the initiator to the responder, said reverse transmission permission granting said responder permission to transmit during said transmit window.

110. The computer program product of claim 109, further comprising instructions for:
determining whether a request for reverse transmission is sent with said clear-to-send signal.

111. The computer program product of claim 109, further comprising instructions for:
determining whether a reverse transmission duration period is sent with said clear-to-send signal.

112. The computer program product of claim 111, further comprising instructions for:
evaluating whether a reverse transmission duration period can be accommodated within a remaining portion of said transmission window.

113. The computer program product of claim 112, further comprising instructions for:
determining whether a difference between a duration of said forward data and said reverse data transmission duration period equals a predetermined value.

114. The computer program product of claim 113, further comprising instructions for:
receiving reverse data from the responder within said transmit window assigned to said initiator when said difference does not equal said predetermined value.

115. The computer program product of claim 114, further comprising instructions for:
sending an acknowledgement of reverse data receipt from the initiator to the responder; and
sending a clear signal from the initiator, said clear signal indicating the initiator relinquishes said transmit window.

116. The computer program product of claim 109, further comprising instructions for:
receiving at the initiator an acknowledgement of forward data receipt from the responder; and
receiving reverse data from the responder within said transmit window assigned to said initiator when said difference does not equal said predetermined value.

117. The computer program product of claim 116, wherein said acknowledgement of forward data receipt and said reverse data are concatenated.

118. The computer program product of claim 116, wherein said acknowledgement of forward data receipt and said reverse data are separated by a predetermined interval.

119. The computer program product of claim 118, wherein said predetermined interval corresponds to a short interframe space.

120. The computer program product of claim 109, further comprising instructions for: advertising an AC (Access Category) to said responder.

121. The computer program product of claim 120, wherein said instructions for advertising comprise instructions for:
signaling said AC (Access Category) with 2 bits.

122. The computer program product of claim 113, further comprising instructions for:
receiving scaled reverse data from the responder when said difference does not equal said predetermined value.

123. The computer program product of claim 124, wherein a duration of said scaled reverse data equals said reverse transmission duration period multiplied by a scaling factor greater than zero and less than 1.

124. A computer program product for wireless communication between an initiator station and a responder station, said initiator being assigned a transmit window having a predefined window duration, said computer program product comprising instructions for:
receiving at the responder a request-to-send signal from the initiator;
sending a clear-to-send signal from the responder to the initiator; and
receiving at the responder forward data and a reverse transmission permission from the initiator, said reverse transmission permission granting said responder permission to transmit during said transmit window.

125. The computer program product of claim 124, further comprising instructions for:
sending a reverse transmission request with said clear-to-send signal.

126. The computer program product of claim 125, further comprising instructions for:
sending a reverse transmission duration period with said clear-to-send signal.

127. The computer program product of claim 126, wherein said reverse transmission duration period can be accommodated within a remaining portion of said transmission window.

128. The computer program product of claim 127, further comprising instructions for:
sending reverse data to the initiator within said transmission window when a difference between a duration of said forward data and said reverse transmission duration period is not equal to a predetermined value.

129. The computer program product of claim 128, further comprising instructions for:
receiving from the initiator an acknowledgement of reverse data receipt at the responder.

130. The computer program product of claim 124, further comprising instructions for:
sending to the initiator an acknowledgement of forward data receipt from the responder.

131. The computer program product of claim 130, further comprising instructions for:
sending reverse data to the initiator within said transmit window assigned to the initiator, wherein said acknowledgement of forward data receipt and said reverse data are concatenated.

132. The computer program product of claim 131, further comprising instructions for:
sending reverse data to the initiator within said transmit window assigned to the initiator, wherein said acknowledgement of forward data receipt and said reverse data are separated by a predetermined interval.

133. The computer program product of claim 132, wherein said predetermined interval corresponds to a short interframe space.

134. The computer program product of claim 124, wherein said instructions for receiving a request-to-send signal from the initiator comprise instructions for:
receiving an advertisement for an AC (Access Category) from said initiator.

135. The computer program product of claim 134, wherein said instructions for receiving an advertisement comprise instructions for:
receiving 2 bits corresponding to said AC (Access Category).

136. The computer program product of claim 134, further comprising instructions for:
formatting said reverse data in accordance with said AC (Access Category); and
sending said reverse data to the initiator within said transmission window when a reverse transmission duration period can be accommodated within a remaining portion of said transmit window.

137. The computer program product of claim 127, further comprising instructions for:
scaling said reverse transmission duration period by a scaling factor greater than zero and less than 1.

138. The computer program product of claim 137, further comprising instructions for:
sending scaled reverse data from the responder to the initiator when said difference does not equal said predetermined value.
